(19) United States
(12) Patent Application Publication
(10) Pub. No.: US 2008/0059349 A1
(43) Pub. Date: Mar. 6, 2008

(54) Method and system for providing tax based services to customers

(76) Inventors: Richard Denis Sweeney, Nashville, TN (US); J. Joseph Gualandri, Metamora, IL (US); Jacquelynn Hunter, Nashville, TN (US); Julie Ann Festa, Nashville, TN (US)

Correspondence Address: CATERPILLAR/FINNEGAN, HENDERSON, L.L.P., 901 New York Avenue, NW, WASHINGTON, DC, 20001-4413, US

(21) Appl. No.: 11/513,281

(22) Filed: Aug. 31, 2006

(51) Int. Cl. G06Q 40/00

(52) U.S. Cl. 705/35

(57) ABSTRACT

A method for assessing taxes for a machine includes collecting machine data from a machine configured to send the machine data to a remote location and determining a first geographic location of the machine based on the machine data. The method also includes determining a first tax due for the machine based on the first geographic location and a first set of tax rules associated with the first geographic location. Before the first tax is due, an analysis may be performed to evaluate whether the first tax can be reduced by moving the machine to a different tax jurisdiction. Based on the results of the analysis, a determination regarding whether to move the machine to the different tax jurisdiction may be made. Information reflecting the determination whether to move the machine to the different geographic location may be provided.

### TECHNICAL FIELD

The present disclosure relates generally to a method and system for locating and assessing taxes on machines, and more particularly, to a method and system for increasing tax savings based on machine locations.

### BACKGROUND

Generally, taxes, such as property taxes, regular taxes, etc. due on a machine are assessed based on tax rules applicable in the jurisdiction where the machine resides on the jurisdiction's tax assessment date. A party responsible for paying the taxes may report the machine's location when assessing its taxes. As a result, the responsible party must be aware of the machine's location during the tax assessment period. This may potentially cause problems when the machine is subject to a lease and the taxes are paid by a responsible party, such as a lessor or financial institution. The lessor or the financial institution may not know exactly where the machine is/was located, especially for mobile machines. Accordingly, the lessor or financial institution may assess the taxes based on information included in an agreement for the machines (e.g. lease agreement, etc). Once paid, the lessor or financial institution may then pass the cost of taxes to the lessee. In some instances, the lessee may dispute the tax assessment because the machine may have been moved to a different tax jurisdiction having different tax rules. This problem may be exacerbated when a lessee has leased multiple machines from a lessor and the machines are geographically distributed. Based on incorrect information, a lessee may be asked to pay taxes for leased machines located in different jurisdictions, each having different tax assessment amounts and due dates.

Furthermore, different jurisdictions (e.g. states, counties and locales) may have different tax rates for different machines and may assess taxes on different dates. As a result it may be advantageous to relocate a machine from one location to another in order to decrease tax liability.

Some systems/methods have been developed that assess taxes based on location information. One method is described in U.S. Pat. No. 5,970,481 (the '481 patent) issued to Westerlage et al. The '481 patent describes a system for determining a tax for a vehicle using positioning technology. The system uses a positioning device operable to determine a plurality of vehicle positions along a route traveled by the vehicle. A processor determines the tax for the vehicle in at least one of the taxing regions through which the vehicle passed based on the vehicle position information. The tax information is then reported to a central location.

Although the system of the '481 patent may provide a mechanism to locate vehicles for assessing taxes, it does not provide responsible parties with advice and information to potentially maximize tax savings.

The disclosed embodiments are directed to overcoming one or more of the problems set forth above.

### SUMMARY OF THE INVENTION

In one aspect, the disclosed embodiments are directed to a method for assessing taxes for a machine. The method includes collecting machine data from a machine configured to send the machine data to a remote location and determining a first geographic location of the machine based on the machine data. The method also includes determining a first tax due for the machine based on the first geographic location and a first set of tax rules associated with the first geographic location. Before the first tax is due, an analysis may be performed to determine whether the first tax due for the machine can be reduced by moving the machine to a different geographic location with different tax rules. The method further includes determining whether to move the machine to the different geographic location based on results of the analysis process in order to reduce the first tax and providing information reflecting the determination whether to move the machine to the different geographic location.

In another embodiment, a method is provided for assessing taxes for a fleet of machines. The method includes determining a location of each machine within the machine fleet, and determining, for each machine in the machine fleet, an appropriate set of tax rules to apply. The method also includes determining, based on the appropriate set of tax rules, a tax due for each respective machine based on the location of the respective machine, and determining a machine fleet tax associated with all of the machines in the machine fleet based on each machine's respective tax. The method further includes determining an effect on the machine fleet tax if one or more of the machines are moved to one or more different locations, and determining whether to move one or more of the machines to one or more respective different locations based on the effect of the machine fleet tax. The method also includes providing a report to a party responsible for paying the machine fleet tax, the report including results of the determining whether to move the one or more machines.

In yet another embodiment a system is provided for assessing taxes on at least one machine based on its location. The system includes a service center configured to collect machine data from a machine configured to send the machine data to a remote location. The service center is also configured to determine a first geographic location of the machine based on the machine data, and to determine a first tax due for the machine based on the first geographic location and a first set of tax rules associated with the first geographic location. The service center is further configured to perform, before the first tax is due, an analysis process to determine whether the first tax for the machine can be reduced by moving the machine to a different location. The service center is also configured to determine whether to move the machine to a different geographic location based on results of the analysis process to reduce the first tax and to provide information reflecting the determination whether to move the machine to the different geographic location.

It is to be understood that both the foregoing general description and the following detailed description are exemplary and explanatory only and are not restrictive of the invention as claimed.

### BRIEF DESCRIPTION OF THE DRAWINGS

FIG. 1 illustrates a system for evaluating and assessing taxes due for a machine consistent with certain disclosed embodiments;

FIG. 2 is a flow chart illustrating an exemplary process for evaluating machine locations consistent with certain disclosed embodiments;

FIG. 3 is a flow chart illustrating an exemplary process for evaluating whether to return a leased machine before a predetermined return date, consistent with certain disclosed embodiments;

FIG. 4 is a flow chart illustrating an exemplary process for evaluating taxes due for machines within a fleet of machines consistent with certain disclosed embodiments; and

FIG. 5 is a flow chart illustrating an exemplary process for collecting machine data and evaluating taxes due for a machine consistent with certain disclosed embodiments.

### DETAILED DESCRIPTION

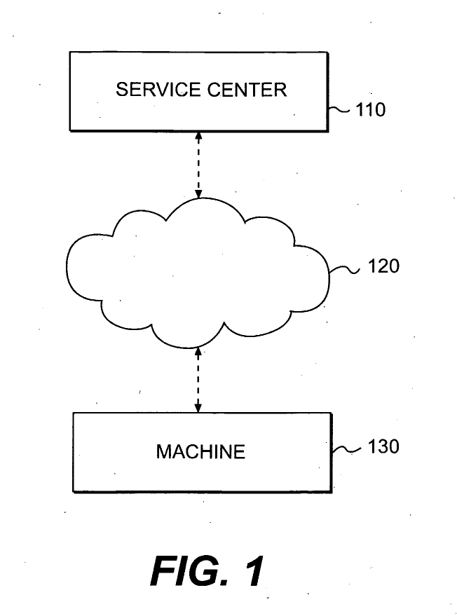

FIG. 1 illustrates a system configured to evaluate and assess taxes due on a machine consistent with certain disclosed embodiments.

Service center 110 may be a computer system configured to collect machine data from one or more machines 130 configured to send machine data to a remote location. Service center 110 may connect to data communication system 120. Service center 110 may also include computer components for receiving, providing, and analyzing information, such as a display device, input/output devices, network connections, a web script, etc. Data communication system 120 may be a system for transferring information, such as any type of wireless/wired networks, the internet, satellite networks, etc. Machine 130 may be one or more machines.

Service center 110 may include one or more processors for performing one or more processes consistent with the disclosed embodiments. Further, service center 110 may include one or more memory devices (not shown) that store collected machine data and information used by the processor(s). Service center 110 may also be configured to determine a first geographic location of machine 130 based on the machine data. In another embodiment, service center 110 may also be configured to determine a tax due for the machine 130 based on the first geographic location by applying a first set of tax rules associated with the first geographic location. Service center 110 may include a database (not shown) to store tax rules (e.g., federal, state, and local) applicable to given jurisdictions. The database may also include tax rules for a plurality of jurisdictions.

Service center 110 may further be configured to perform an analysis process to determine whether the first tax can be reduced. For example, before the first tax is due to a given entity, service center 110 may analyze tax rules from different jurisdictions to determine whether moving machine 130 to any of these different jurisdictions would reduce the amount of tax due. Service center 110 may also analyze costs associated with moving the machine 130 to the different tax jurisdiction. Service center 110 may further generate a report comparing the first tax due at the first location with the reduced tax attainable by moving the machine to a different location plus costs associated with moving the machine to the different location. Based on this data, service center 110 may provide a recommendation whether or not to move the machine to the different location. Service center 110 may also perform this analysis for machines in a given fleet.

Service center 110 may further be configured to collect data on a machine or plurality of machines under a lease contract. The data collected may include lease end dates, term of leases, and parties responsible for paying taxes on the machine 130 during its lease term. Service center 110 may also determine whether returning a leased machine earlier than its lease end date would result in a reduction of taxes due. For example, a machine located in State A may be subject to a lease. State A may assesses taxes on July 1. The machine's lease term may terminate on July 5. By returning the machine on June 30, the lessee, if the lessee is the responsible party paying taxes, may not have to pay taxes that would be assessed on July 1. Service center 110 may generate a report and forward the report to the party responsible for paying taxes during the machine's lease term.

Machine 130 may be a commercial machine, such as a truck, crane, earth moving machine, mining vehicle, material handling equipment, farming equipment, marine vessel, aircraft, an excavator, a dozer, a loader, a backhoe, a motor grader, a dump truck, or any type of machine that operates in a work environment such as a construction site, mine site, power plant, etc.

Machine 130 may be equipped with a data communication system (not shown) for transmitting the data to the remote location. Any data communication system known in the art may be used. For example, the machine 130 may be equipped with a computer, a network, an electronic control module, wireless communication capabilities, communication via global positioning satellite, etc. Machine 130 may also include multiple data communication systems.

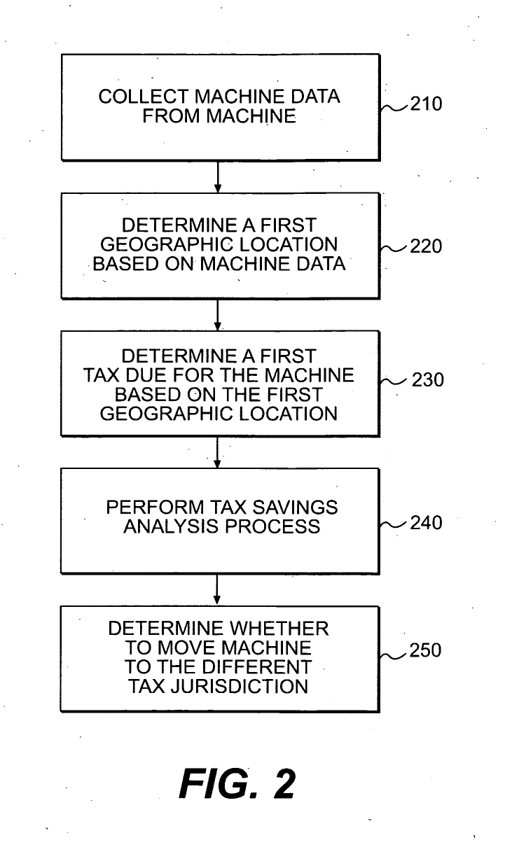

FIG. 2 is a flow chart showing a process that may be employed to evaluate and analyze taxes due for machine 130. Machine 130 may be configured to send machine data which is collected by a remote location (e.g., service center) (Step 210).

The service center 110 may determine a first geographic location of the machine based on the machine data (Step 220). For example, machine 130 may send GPS-related information to allow the service center 110 to determine the geographic location of machine 130. It should be noted that other types of information may be used to determine the location of machine 130. Further, the machine data may also include machine operation data such as the machine's usage, hours of operation, nature of operation, parameter values, etc.

Service center 110 may be configured to determine a first tax due for machine 130 based on the machine data collected from machine 130 (Step 230). For example, service center 110 may maintain one or more data structures of tax data and rules for different jurisdictions. Alternatively, service center 110 may request and receive one tax data and rules. Based on this tax data and rules for the first geographic location, service center 110 may determine a first tax due for machine 130. For example, the tax due may be property taxes accrued based on tax rules applicable in the first geographic location of machine 130. The tax due may also be as a result of the usage of machine 130 in the first geographic location. The tax due may also be calculated from federal, state, county, and/or local tax rules.

Before the first tax is due, service center 110 may perform a tax savings analysis process to determine whether the first tax can be reduced if the machine 130 is moved to a different tax jurisdiction (Step 240). The analysis process may include determining how long machine 130 must reside in the first location before taxes are assessed and whether taxes are assessed for the entire tax period or for the specific duration the machine resides in the first location. The analysis process may also include determining the tax rules for a different tax jurisdiction, determining when taxes are due in the different tax jurisdiction, and determining how long machines must reside in the different tax jurisdiction before taxes are assessed, etc. Based on the results of the analysis, a determination may be made regarding whether to move the machine 130 to the different tax jurisdiction (Step 250).

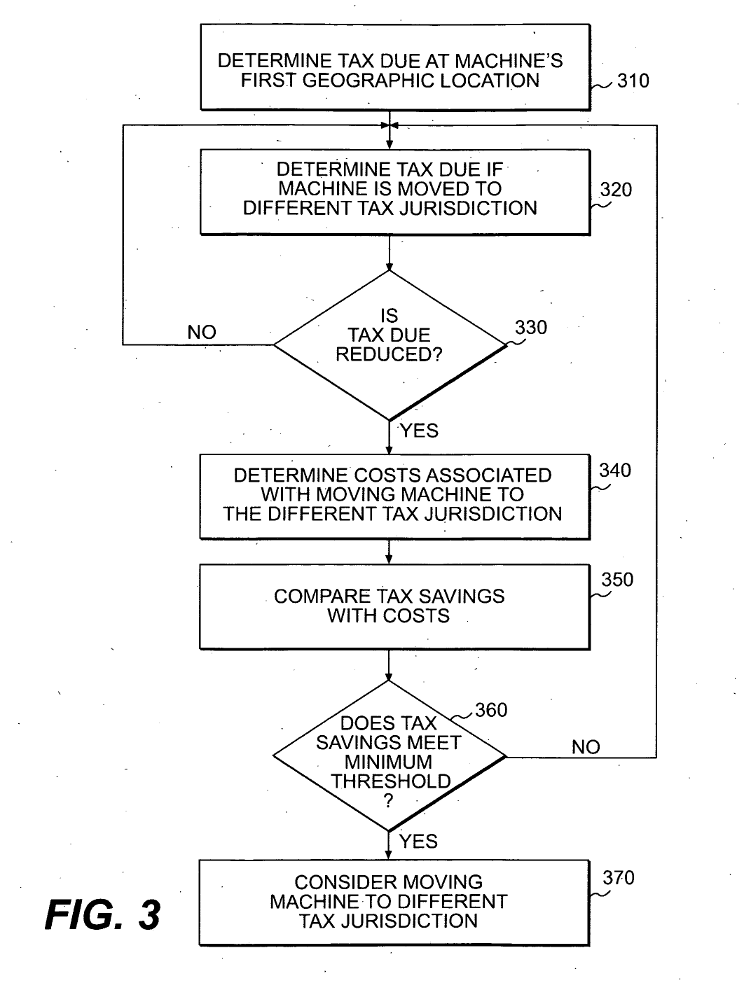

FIG. 3 illustrates a move analysis process for determining whether to move a machine to a different tax jurisdiction consistent with certain disclosed embodiments. The move analysis process may be performed by service center 110 or other type of remote location. Initially, the tax due for machine 130 at a first location may be determined (Step 310). As explained above, the tax may be determined based on how long machine 130 has resided in the first location in light of applicable federal, state, and/or local tax rules. The move analysis process may also include determining the tax due if the machine 130 is moved to a different tax jurisdiction (Step 320). To do so, in one embodiment; the move analysis process may include determining tax rules for the different tax jurisdiction, determining when taxes are due in the different tax jurisdiction, determining how long machine 130 must reside in the different tax jurisdiction before taxes are assessed, etc.

The tax due for machine 130 when located in the different tax jurisdiction may be compared to the tax due if machine 130 is kept in the first jurisdiction. This comparison may determine if the tax due for machine 130 in the different tax jurisdiction is less than the tax due at the first location (Step 330). If the tax due at the different tax jurisdiction is reduced, the costs associated with moving machine 130 to the different tax jurisdiction may be determined (Step 340). However, if the tax due for moving the machine to the different location is not reduced, another different location may be selected to determine if moving the machine to the other different location would result in a reduction in tax due (Step 320).

The costs associated with moving machine 130 to the different tax jurisdiction may include, for example, transportation costs such as fuel costs, tolls, freight charges, charges to load and unload the machine onto the transporting carrier, costs based on traffic patterns, storage costs, etc. Costs associated with moving machine 130 to the different tax jurisdiction may also include productivity costs, including, but not limited to, work schedules of personnel qualified to move the machine, pay rate (e.g., salary, wage, etc.) of personnel qualified to move machine 130, availability of a replacement machine to replace machine 130 at the first location if it is moved to the different jurisdiction, costs associated with implementing and operating the replacement machine, cost for transporting the replacement machine to the first location, and any other costs associated with moving machines or related equipment. Costs associated with moving the machine may also include costs to a business operation for lack of productivity due to the unavailability of machine 130 at the first location, costs for downtime when a replacement machine is implemented at the first location, and costs to a business operation including a fleet of machines. It should be noted that the above costs are exemplary and not intended to be limiting. The disclosed embodiments may determine any type of costs associated with machine 130, other machines, a machine fleet, a business entity related to machine 130, etc.

The move analysis process may also include comparing the reduction in tax due to the costs associated with moving machine 130 to the different tax jurisdiction (Step 350). If the tax savings (or reduction in tax) is larger than the costs associated with moving machine 130 to the different tax jurisdiction, a determination may be made to ascertain whether the tax savings meet an established minimum threshold value (Step 360).

For example, service center 110 may define one or more threshold values used to assist the determination in moving machine 130. For instance, the threshold value may be a percentage value, a fixed value, a dynamic value, etc. related to the type of machine 130. If, for example, the tax savings are 15 percent more than the determined costs, the move analysis process may determine the tax savings meet the minimum threshold. Other types of thresholds may be implemented. If the tax savings meets the minimum threshold, the move analysis process may determine whether to move the machine 130 to the different tax jurisdiction (Step 370). If, however, the attainable tax savings does not meet the minimum threshold, another different tax jurisdiction may be selected and the move analysis process repeated (e.g., Step 330).

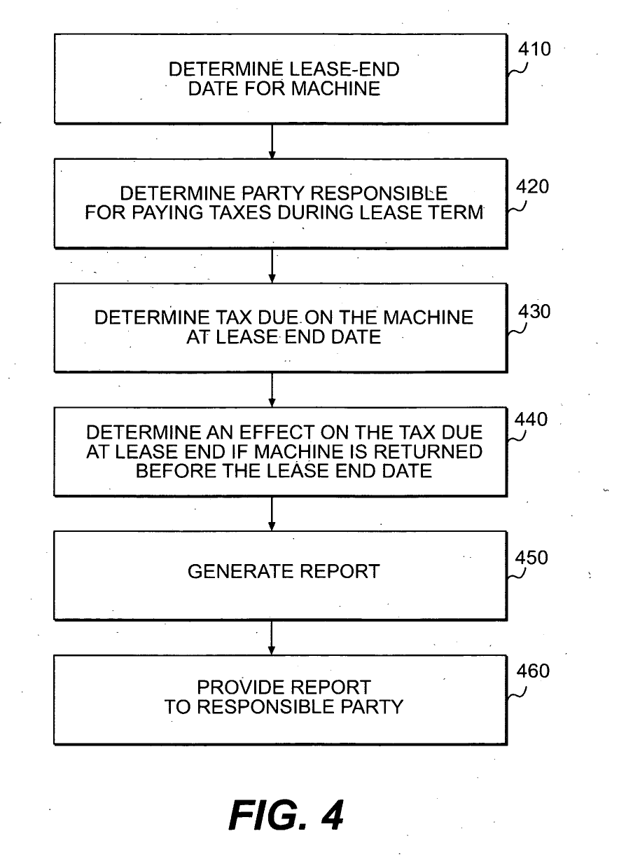

FIG. 4 illustrates a flow chart of a move analysis process consistent with disclosed embodiments when machine 130 is subject to a lease. In one embodiment, service center 110 may perform the process of FIG. 4. Initially, the end of a lease term for machine 130 may be determined (Step 410). A party responsible for paying taxes during the lease term may also be determined (Step 420). In this example, the party responsible for paying the taxes may include a lessee, a lessor, a financing institution, and any other type of entity (corporate, individual, etc.). Further, the tax due for machine 130 at the end of the lease term may be determined (Step 430). As explained above, the tax may be determined based on how long machine 130 has resided in the first location in light of applicable federal, state, and/or local tax rules. Also, in this example, any taxes due based on machine 130 being leased are considered when determining the tax due.

Based on the determined tax due at the end of the lease term, the move analysis process may determine an effect on the tax due if machine 130 is returned before the lease end date. (Step 440). For example, a process may be performed that evaluates different return dates and their corresponding tax implications and costs associated with each return date. For instance, the process may evaluate traffic, shipping, transportation, remittances, etc. when returning machine 130 on a given date. The move analysis process may also include travel directions to the different geographic location.

Based on the determined effect, the process may generate a report indicating the effect and providing one or more options available to an entity responsible for machine 130 (Step 450). The report may be provided to any individual or entity, such as the party responsible for paying the taxes (Step 460). For example, machine 130 may be located in State A, which assesses taxes on July 1. Machine 130 may be subject to a lease having a lease end date of July 5. By returning the machine 130 on June 30, the lessee (e.g., the responsible party paying taxes) may avoid payment of the taxes assessed on July 1, and thus experience tax savings. The report may include an indication of a move date for moving the machine to the different geographic location.

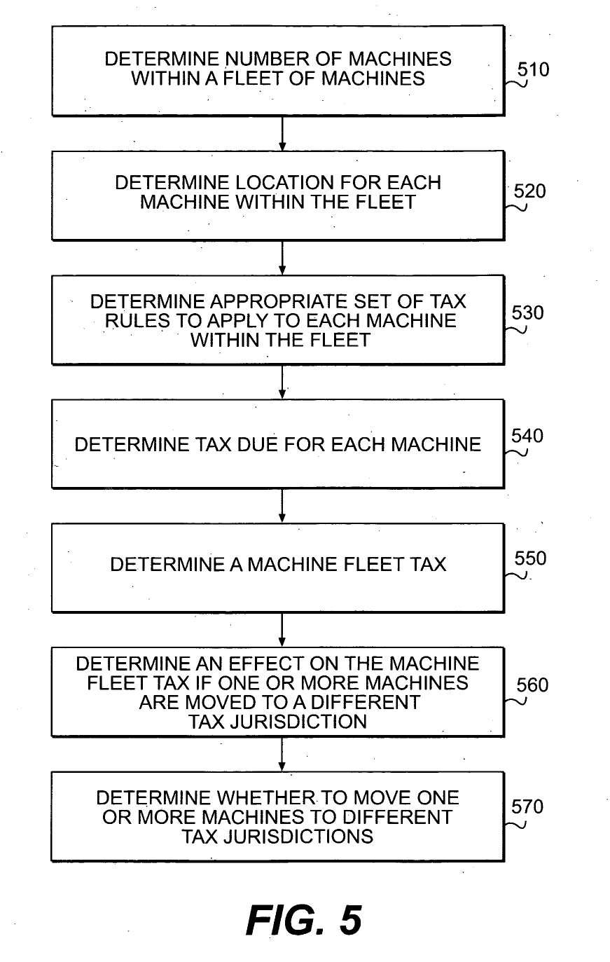

FIG. 5 shows a flow chart of an exemplary machine fleet process for evaluating taxes due on machines within a fleet of machines, consistent with certain disclosed embodiments. A machine fleet may include a set of machines. The machine fleet may include one or more similar types of machines, and/or one or more different types of machines. Further, the machines in the fleet may be geographically distributed across different tax jurisdictions, or the entire fleet may be located within a single tax jurisdiction. The machine fleet process may determine the number of machines within a given fleet (Step 510). To do so, in one example, one or more remote locations, such as a service center 110, may collect machine data from each machine 130 in the fleet. Based on the machine data, the geographic location of each machine within the fleet is determined (Step 520). Based on the determined locations the process determines an appropriate set of tax rules that may be applicable to each respective machine (Step 530). The appropriate set of tax rules may each include federal, state, county, and/or local tax rules applicable in the location where each respective machine resides. The appropriate set of tax rules may also include tax rules regarding usage of machines in their respective locations. The appropriate tax rules may be applied to determine a tax due for each machine in the fleet (Step 540). Based on each machine's tax due, a machine fleet tax due is determined (Step 550).

The machine fleet process may also determine an effect on the machine fleet tax if one or more machines are moved to a different tax jurisdiction (Step 560). The analysis may include determining an effect on a tax due on each machine if that machine is moved to a different jurisdiction. The determination may include analyzing the costs for moving each machine to its respective different jurisdiction. The analysis may also include determining when the tax is due for each machine in its respective jurisdiction. For example, machine A of a first machine fleet may have taxes due on January 1 while machine B, within the same first fleet, may have taxes due on June 1. The analysis may include determining where to locate each machine prior to its respective tax due date to reduce tax liability. The analysis may also include determining how long each machine must reside in a specific location to be subject to taxation in that location.

Based on the determined effect on the machine fleet tax the machine fleet process may determine whether to move one or more machines to different tax jurisdictions (Step 570). The determination may include considering whether the machine fleet tax is reduced as a result of moving one or more machines to a different tax jurisdiction. Costs associated with moving one or more machines to the different tax jurisdiction may be compared to the tax savings attainable due to the reduction in taxes. If the tax savings is higher than the costs, and meets an established minimum threshold value, the machine fleet process may generate information reflecting one or more options for moving identified one or more machines.

Move plans may be developed for the one or more options for moving identified machines. The move plans may include how to best relocate the one or more machines to different tax jurisdictions to minimize costs associated with moving the one or more machines. A report including the move plans and the determination whether to move one or more machines to different tax jurisdiction may be generated. The report may be provided to the responsible party.

As discussed above in connection with FIG. 3, costs associated with moving one or more machines to different tax jurisdictions may include transportation costs and the availability of replacement machines to replace machines moved to different jurisdictions. Preferably, replacement machines may be machines within the same fleet. In one embodiment, the machine fleet process may identify a replacement machine from among machines within the fleet that are designated for movement from their jurisdictions. However, machines from different fleets may be used to replace machines in the first fleet. For example, it may be determined that moving machine A to a different jurisdiction reduces the machine fleet tax and moving machine B to a different jurisdiction also reduces the machine fleet tax. Machines A and B and their respective tax liabilities in both jurisdictions may be compared to determine if they may replace each other and still maintain the reduced machine fleet tax. If so, machines A and B may be moved to replace each other.

Costs associated with moving one or more machines to different tax jurisdictions may also include costs associated with implementing and operating replacement machines, cost for transporting the replacement machines to the different locations, costs to a business operation for lack of productivity because of unavailability of machines, costs for downtime when replacement machines are implemented, and costs to a business operation including how moving machines to different locations within a given fleet of machines may affect other machines within the given fleet of machines. For example, certain machines within a fleet may have to operate together or in tandem, and moving one machine may require moving another machine, with which it works in concert, as well.

In one embodiment, the machines within the fleet may be subject to respective lease terms having varying lease end dates. Lease end dates for each of the machines may be determined. A party responsible for paying taxes during the lease term of each respective machine may also be determined. For example, different machines within a given fleet may have a different party responsible for paying taxes during the respective machine's lease term. Each responsible party may include a lessee, a lessor, a financing institution, a third party, etc. The tax due on each respective machine may also be determined based on, for example, how long each respective machine has resided in its first location based on applicable federal, state, and/or local tax rules for the machine in its respective jurisdiction. In addition, any taxes resulting from the machines being subject to a lease may be considered. Based on the above analysis, the machine fleet process may determine an effect on the machine fleet tax if one of more machines are returned prior to their respective lease term end dates. A report may be generated, reflecting one or more options related to the determined effect on the machine fleet tax and the report may be provided to the respective responsible parties.

It should be noted that the steps of FIGS. 2-5 may be performed in any order.

### INDUSTRIAL APPLICABILITY

The disclosed embodiments may leverage real time machine data to accurately locate machines for tax assessments. Assessing taxes for machines may include evaluating whether to move one or more machines to different tax jurisdictions to increase tax savings and determining whether to return a leased machine prior to a lease end date to reduce or eliminate tax liability.

For example, a machine located in a first jurisdiction and subject to a first set of tax rules applicable in the first jurisdiction, may be subject to taxes on January 1. Prior to the January 1 tax assessment date, analysis may be performed to determine whether tax savings would be achieved by moving the machine to a different tax jurisdiction that may have a lower tax rate. Analysis may also be performed to evaluate whether to move the machine to a different tax jurisdiction that assess taxes later in the year, such as on June 1. By moving the machine to a jurisdiction that assess taxes later in the year, tax savings based at least on the time value of money may be achieved.

Before deciding to move a machine to a different jurisdiction, analysis may be performed to determine how much it will cost to move the machine to the different jurisdiction. The analysis may take into account transportation costs, including cost of loading the machine, cost of the carrier to move the machine, cost of a replacement machine, including implementation costs, if a replacement machine is needed, and cost to off-load and store the machine. The tax savings attainable from moving the machine to the different location may be compared to the costs involved with moving the machine to the different location. A minimum threshold of savings may be evaluated to determine whether to move a machine. If the tax savings attainable by moving the machine to a different location exceeds the costs involved with moving the machine and also meets the minimum threshold, the disclosed embodiments may provide a report indicating that the machine should be moved to the different location. As a result, the machine is moved.

In other embodiments, the machine may be subject to a lease and the lessor may be responsible for paying the taxes on the machine during the lease term. In certain agreements, the lessor may transfer the cost of the tax to the lessee. By implementing the disclosed embodiments, the lessor will know the exact location of the machine and therefore may assess an accurate tax liability. For example, the machine may have been moved from its original location to a new location during the lease term. The lessor may present a report to the lessee showing the exact location of the machine and its exact usage when forwarding the amount of tax paid to the lessee.

In another embodiment, a lessee may use the disclosed embodiments to determine whether to return a leased machine before the lease end date to attain tax savings. For example, the lease end date may be July 5 while tax assessment date for the machine may be June 30. The disclosed embodiments may provide a report to the lessee assessing tax savings attainable to the lessee based on alternate return dates.

In accordance with certain disclosed embodiments, a machine fleet tax may also be determined. In one embodiment, the machine fleet tax may be determined by summing the taxes due for each machine in the fleet. The disclosed embodiment may determine whether the machine fleet tax may be reduced. The determination may include evaluating tax savings attainable if one or more machines within the fleet are moved to one or more different locations. Costs involved with moving the one or more machines may also be considered in assessing tax savings. For example, moving machine A to a different jurisdiction may reduce the machine fleet tax. Further, analysis may be performed to determine if there is a suitable replacement machine for machine A within the given fleet. The analysis may also include determining a suitable replacement machine for machine A that if moved would also achieve tax savings. For example, machine B might be a suitable replacement for machine A, and moving machine B to the jurisdiction where machine A currently is located may reduce the machine fleet tax. Furthermore, the machines within the fleet may be located in locations having different tax assessment dates. Thus, the disclosed embodiments may determine whether to move one or more machines based on respective tax assessment dates for different jurisdictions to achieve tax savings.

Maximizing tax savings may include comparing attainable tax savings between different new tax jurisdictions, comparing the attainable tax savings to costs associated with moving machines, and choosing the best jurisdiction. It should be noted that the application of the tax savings embodiment and/or the embodiment to minimize tax liability may be related to any type of machine, industry, etc.

It will be apparent to those skilled in the art that various modifications and variations can be made to the method and system for locating and assessing taxes on machines. Other embodiments will be apparent to those skilled in the art from consideration of the specification and practice of the disclosed method and system for locating and assessing taxes on machines. It is intended that the specification and examples be considered as exemplary only, with a true scope being indicated by the following claims and their equivalents.

What is claimed is:

1. A method for assessing taxes for a machine, comprising:
collecting machine data from a machine configured to send the machine data to a remote location;
determining a first geographic location of the machine based on the machine data;
determining a first tax due for the machine based on the first geographic location and a first set of tax rules associated with the first geographic location;
performing, before the first tax is due, an analysis process to determine whether the first tax due for the machine can be reduced;
determining whether to move the machine to a different geographic location based on results of the analysis process to reduce the first tax; and
providing information reflecting the determination whether to move the machine to the different geographic location.

2. The method of claim 1, wherein the first geographic location is within a first jurisdiction and performing the analysis process includes:
determining a second tax due for the machine if the machine is located in a second jurisdiction; and
determining whether to move the machine from the first jurisdiction to the second jurisdiction based on at least the first and second taxes.

3. The method of claim 1, wherein the machine is leased from a lessor for a lease term that ends on a lease end date, and the analysis process includes:
determining a party responsible for paying taxes for the machine during lease term;
determining a second tax due for the machine at the lease end date;
determining an effect on the second tax if the machine is returned to the lessor before the lease end date
generating a report based on the determined effect on the second tax; and
forwarding the report to the responsible party.

4. The method of claim 3, wherein determining the effect on the second tax includes:
determining a return date for returning the machine to the lessor that minimizes an amount of tax due to the machine; and
providing in the report the return date and at least one of the amount of tax due for the machine or an amount of savings to the responsible party if the machine is returned to the lessor on the return date.

5. The method of claim 4, wherein the different geographic location is associated with the lessor and determining whether to move the machine to the different geographic location based on results of the analysis process includes:
moving the machine from the first geographic location to the different geographic location before the lease end date.

6. The method of claim 1, wherein the tax rules include at least one of federal, state, and local tax rules.

7. The method of claim 1, wherein performing the analysis process includes:
determining costs associated with moving the machine to the different geographic jurisdiction; and
comparing the costs with any tax savings attainable by moving the machine to the different geographic jurisdiction.

8. The method of claim 7, wherein determining costs includes at least one of:
determining productivity costs associated with a loss of usage of the machine at the first geographic location; and
determining transportation costs associated with moving the machine from the first geographic location to the different geographic location.

9. The method of claim 8, wherein determining transportation costs includes at least one of determining a cost of fuel, distance to travel between the first and different geographic locations, and estimated traffic patterns between the first and different geographic locations; and
wherein determining productivity costs includes at least one of work schedules of personnel who are qualified to move the machine, pay rate of personnel who are qualified to move the machine, availability of a replacement machine to replace the machine if it is moved to the different geographic location, a cost of operating the replacement machine, a cost of transporting the replacement machine to replace the machine, and a cost to a business operation including a fleet of machine.

10. The method of claim 1, wherein the analysis process includes:
determining costs associated with moving the machine to the different geographic location;
determining a move date for the machine that increases tax savings to a party responsible for paying the first tax based on the determined costs and the first tax due date.

11. The method of claim 1, wherein providing information includes:
generating a report based on the analysis process; and
providing the report to a party responsible for paying the first tax, the report including at least one of:
an indication of the first tax due on the first tax due date to be paid by the responsible party;
an indication of a second tax due on a second tax due date to be paid by the responsible party if the machine is moved to the different geographic location;
an indication of tax savings to the responsible party if the machine is moved to the different geographic location;
an indication of a move date for moving the machine to the different geographic location;
travel directions to the different geographic location; and
an indication of costs to the responsible party for moving the machine to the different location.

12. A method for assessing taxes for a fleet of machines, comprising:
determining a location of each machine within the machine fleet;
determining, for each machine in the machine fleet, an appropriate set of tax rules to determine a tax due for a respective machine based on the location of the respective machine;
determining, based on the appropriate set of tax rules, a tax due for each machine based on each machine's location; determining a machine fleet tax associated with all of the machines in the machine fleet based on each machine's respective tax;
determining an effect on the machine fleet tax based on whether one or more of the machines are moved to one or more respective different locations;
determining whether to move one or more of the machines to one or more respective different locations based on the effect of the machine fleet tax; and
providing a report to a party responsible for paying the machine fleet tax, the report including results of the determining whether to move the one or more machines.

13. The method of claim 12, wherein determining an effect on the machine fleet tax includes:
determining, for each machine in the fleet, costs associated with moving the respective machine from its determined location to the different location;
comparing, for each machine in the fleet, the costs for moving that respective machine to any tax savings if the respective machine is moved to the different location;
determining a move plan for machines in the fleet that reduces costs to the responsible party, the move plan includes identifying machines in the fleet that if moved, provides tax savings that exceed any costs to move the machines to their respective different locations; and
providing the move plan in the report.

14. The method of claim 12, wherein the machines within the fleet are leased from a lessor for a lease term for each respective machine that ends on a lease end date for each respective machine, the method further including:
determining a party responsible for paying taxes for the respective machines during their respective lease terms;
determining a second tax due for each respective machine at the lease end date for each respective machine;
determining an effect on the second tax if the machines are returned to the lessor before their respective lease end dates;
generating a report based on the determined effect on the second tax; and forwarding the report to the responsible party.

15. The method of claim 14, wherein determining the effect on the second tax includes:
determining a return date for returning the respective machines to the lessor that minimizes an amount of tax due to the respective machines; and
providing in the report the respective return dates aria at least one of the amount of tax due for the machines or an amount of savings to the responsible party if the machines are returned to the lessor on their respective return dates.

16. The method of claim 15, wherein the one or more respective different geographic locations are associated with the lessor and determining whether to move the machines to the one or more respective different geographic locations based on the effect of machine fleet tax includes:
moving the respective machines from the first geographic location to the one or more respective different geographic locations before their respective lease end dates.

17. A system for assessing taxes on at least one machine based on its location, comprising:
a service center configured to:
collect machine data from a machine configured to send the machine data to a remote location;
determine a first geographic location of the machine based on the machine data;
determine a first tax due for the machine based on the first geographic location and a first set of tax rules associated with the first geographic location;
perform, before the first tax is due, an analysis process to determine whether the first tax due for the machine can be reduced;
determine whether to move the machine to a different geographic location based on results of the analysis process to reduce the first tax; and
provide information reflecting the determination whether to move the machine to the different geographic location.

18. The system of claim 17, wherein the first geographic location is within a first jurisdiction and performing the analysis process includes:
determine a second tax due for the machine if the machine is located in a second jurisdiction; and
determine whether to move the machine from the first jurisdiction to the second jurisdiction based on at least the first and second taxes.

19. The system of claim 17, wherein the machine is leased from a lessor for a lease term that ends on a lease end date, and the analysis process includes:
determine a party responsible for paying taxes for the machine during lease term;
determine a second tax due for the machine at the lease end date;
determine an effect on the second tax if the machine is returned to the lessor before the lease end date
generate a report based on the determined effect on the second tax; and
forward the report to the responsible party.

20. The system of claim 17, wherein determine the effect on the second tax includes:
determine a return date for returning the machine to the lessor that minimizes an amount of tax due to the machine; and
provide in the report the return date and at least one of the amount of tax due for the machine or an amount of savings to the responsible party if the machine is returned to the lessor on the return date.
